(19) United States
(12) Patent Application Publication
(10) Pub. No.: US 2006/0041864 A1
(43) Pub. Date: Feb. 23, 2006

(54) Error estimation and tracking tool for testing of code

(75) Inventors: Lane Thomas Holloway, Pflugerville, TX (US); Walid M. Kobrosly, Round Rock, TX (US); Nadeem Malik, Austin, TX (US); Marques Benjamin Quiller, Pflugerville, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/921,433

(22) Filed: Aug. 19, 2004

(51) Int. Cl. G06F 9/44

(52) U.S. Cl. 717/124

(57) ABSTRACT

Methods, systems, and media are disclosed for assisting in testing a section of code during code development. One embodiment includes identifying a section of code for testing, and retrieving historical test data and current bug data from one or more databases for the section of code. The historical test data includes test results, for example, for previous test scripts written for the section of code, and the bugs recorded against the previous versions of the section of the code. The current bug data, for instance, includes the current bugs and what developer(s) wrote the current section of the code. The embodiment also includes analyzing the historical test data and the current bug data to yield an estimate of errors remaining in the section of code. Finally, the embodiment includes displaying the estimate, whereby the estimate assists in scheduling and test scripting for the section of code.

### FIELD OF INVENTION

The invention generally relates to the testing of code during code development. More particularly, the invention relates to methods, systems, and media for estimating errors remaining in code through an application, such as a plug-in, within the integrated development environment, wherein the estimate provides testers with assistance in accurate scheduling and divining further test scripting for the remaining bugs in the code.

### BACKGROUND

Often two or even a team of computer programmers, i.e., developers, write a computer program's code (“code”). The code, itself, is a set of instructions, written in one or more computer languages, such as C, C++, and Java, for a computer system to interpret and execute in order to produce a particular program's underlying functionality. The process for writing the code, which forms the basis of the program, is called code development.

Code development is an arduous, complex, and time-consuming task—especially so for code employing novel programming techniques, enabling innumerable functionalities, and requiring thousands or even millions of lines of code. Oftentimes, a team of developers develops the code within an integrated development environment (“IDE”). An IDE, itself, is a programming environment integrated into a software application that often provides a graphical user interface (“GUI”) builder, a text or code editor, a compiler, and/or interpreter, and a debugger. With the IDE, developers meet the daunting challenges of code development: designing and planning system architecture, as well as writing, editing, and re-writing endless lines of code, usually located in an accessible code repository, to produce a final and current version of the code. Examples of IDEs include Eclipse™, JTogether™, Visual Studio®, Delphi®, JBuilder®, FrontPage® and DreamWeaver®, wherein the latter two are for HTML and web page development.

After developing the entire, or, more advisably, a section of code, the testing phase for that code begins, a phase that often requires between 10 and 30 percent of the total time for code development. During this distinct phase of the code development process, testers write test scripts, i.e., test cases, against the code. Testers craft many and various test scripts for testing the code from all possible angles with an aim at ensuring that the code is functional, useable, and performs, as intended, under any and all circumstances. To enable this quality assurance before shipping the code to consumers, testers often perform their function under quarantine from developer's influence so that objectivity in test writing and results occurs. Further, in addition to writing test scripts, testers employ a host of bug tracking tools, such as Bugzilla®, as well as logical and physical peripherals, such as a bug tracking database, associated with the testing environment to keep and record the bug testing results. Such tools and peripherals assist testers in identifying the amount and type of errors in the code, which, in turn, assists the tester in crafting better test scripts to understand the root cause of the errors. As a result, the better test scripts inure to the benefit of the developer because the developer can then re-code in hopes of removing the well-identified errors remaining in the code.

After testing a section of code that yields errors, i.e., failures, further coding is required to correct these errors, whereupon that section of code is re-tested to determine if it now passes testing before allowing shipment of that section of code. As a result, the cyclical and iterative nature of code development process is obvious: code, test, code, test, etc. Alongside the time-consuming nature of code development is the true schedule for code development. That is, knowing when the code will be complete is important to a business, but this is often difficult for a code development team to accurately prognosticate. Unexpected difficulties in writing shippable code often arise, and developers are notoriously crabby about making schedules. The “it will be done when it's done” answer exclaimed by developers is not helpful, and, sometimes, is simply unacceptable to a business waiting on the finished version of the code.

Despite the code development team having an IDE tool and various testing tools for developing bug-free code, problems remain for testers in determining an accurate schedule for delivering the code, working as intended. Further, despite having and using these tools, problems remain for testers in not being able to quickly identify the amount and type of errors during code development; that is, as the code development team is writing the code. Instead, the state of the art typically waits until at the end, that is, after release of the code, to inform the code development team that the code should have been written in a particular manner for a particular code function. What is needed, therefore, are methods, systems, and media for assisting in testing code during the development process and within an integrated development environment for estimating the amount and type of errors remaining in the code, so as to assist with accurate scheduling and better test scripting before release of the code.

### SUMMARY OF THE INVENTION

Embodiments of the invention generally provide methods, systems, and media for assisting in testing of code in an integrated development environment. In one embodiment, the method includes identifying the section of code for the testing. Further, the method includes retrieving historical test data and current bug data from one or more databases for the section of code. Further still, the method includes analyzing the historical test data and the current bug data to yield an estimate of errors remaining in the section of code. Yet further, the method includes displaying the estimate, whereby the estimate assists in scheduling and test scripting for the section of code.

In another embodiment, the invention provides a system for assisting in testing of code in an integrated development environment. The system generally includes an application within the integrated development environment. The system further includes an identification module of the application for identifying the section of code for the testing, and a retriever module of the application for retrieving historical test data and current bug data from one or more databases for the section of code. In addition, the system includes an analyzer module of the application for analyzing the historical test data and the current bug data and for yielding an estimate of errors remaining in the section of code. Finally, the system includes a display module of the application for displaying the estimate.

In yet another embodiment, the invention provides a machine-accessible medium containing instructions for assisting in testing a section of code in an integrated development environment, which when executed by a machine, cause the machine to perform operations. The instructions generally include operations for identifying the section of code for the testing. The instructions further include operations retrieving historical test data and current bug data from one or more databases for the section of code, and operations for analyzing the historical test data and the current bug data to yield an estimate of errors remaining in the section of code. Further still, the instructions include operations for displaying the estimate, whereby the estimate assists in scheduling and test scripting for the section of code.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an overview of a system for assisting in testing a section of code in an integrated development environment in accordance with the disclosed invention.

FIG. 2 depicts an example embodiment of a system for assisting in testing a section of code in an integrated development environment in accordance with the disclosed invention.

FIG. 3 depicts an example embodiment of an estimate in accordance with the disclosed invention.

FIG. 4 depicts an example embodiment of a flowchart for assisting in testing a section of code in an integrated development environment in accordance with the disclosed invention

FIG. 5 depicts an example embodiment of a computer system capable of use for assisting in testing a section of code in an integrated development environment in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for assisting in testing a section of code in an integrated development environment are contemplated. Embodiments include an integrated development environment (“IDE”), which, generally, is understood to be accessed by one or more networked computer systems that one or more testers of the collaborative code development team uses for testing code developed by programmers, i.e., developers. Specifically, an IDE is a programming environment integrated into a software application that often provides a graphical user interface (“GUI”) builder, a text or code editor, a compiler, and/or interpreter, and a debugger or bug recording tool. A code repository, that is, for holding, as well as checking in and out, the code under development is also usually associated with the IDE. Within the IDE, embodiments further include an application, such as a plug-in to the IDE, for easy and convenient access and calculation of an estimate of remaining errors in the code, wherein the estimate provides the tester with a way to more accurately schedule and write better test scripts for these remaining errors. The application includes functionalities, whether in one or a plurality of modules, for identifying a section of code that a tester desires to test. After identifying the section of code for testing, the application retrieves historical test data and current bug data from one or more databases for the section of code. The historical test data includes test results from previous test scripts run against the section of code; in a sense, this is a “lessons learned” archive for the section of code. In order to retrieve the current bug data from the section of code, the current section of code communicates with a bug recording tool, wherein the application transfers and stores the current bugs and any associated data, such as developer statistics located in the IDE, such as the code repository, into the one or more databases. After retrieving, the application analyzes the historical test data and the current bug data (collectively “data”). The analyzing may occur through a default setting or by the tester choosing which qualifiers or which pre-programmed algorithms to run in order to compare the current bug data to the historical test data. Through this analyzing, the application yields an estimate of the amount and type of errors remaining in the section of code. That is, the analyzing, for example, looks at the skill set of the developer(s) used, complexity, and time necessary for solving previous bugs found in the historical test data, and then compares this information to the current bug data to yield an estimate of the errors remaining in the section of code. The application further displays this estimate, which may include the time and developer skill set necessary to remove the remaining errors in the section of code. As a result, based on estimate derived from the historical data comparison to the current bug data, the tester is provided a means to more accurately predict the true schedule for completion of the shippable section of code, as well as means to write better test scripts for the identified remaining errors in the section of code. After testing the section of code with the new test scripts, the application updates the database with the new test data, which is later viewed as part of the historical test data in new iterations of the invention.

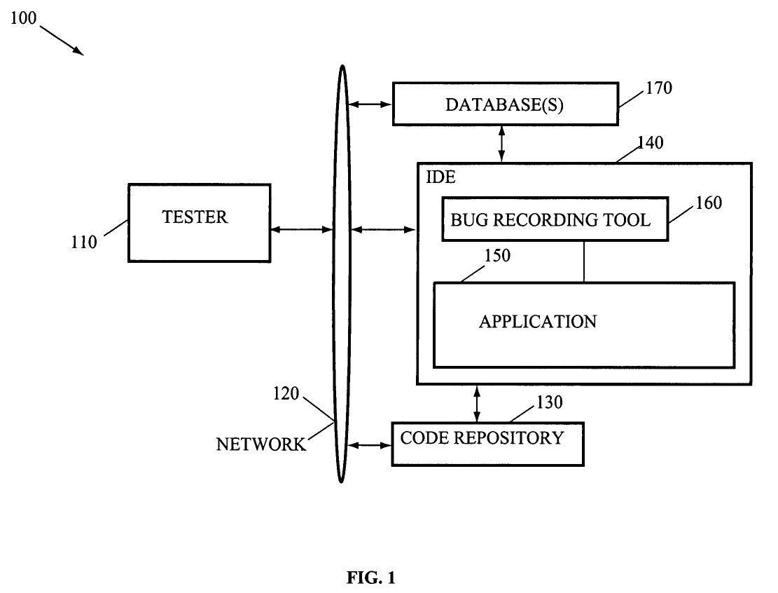

Turning now to FIG. 1, a general overview of a system 100 for assisting in testing a section of code in an IDE, in accordance with the invention, is disclosed. The system 100 includes a computer system 110, likely used by a tester, and, as depicted in FIG. 1. More computer systems used by other testers are clearly possible for the system 100, although such are not depicted.

Tester computer system 110, which optionally includes a host of physical and logical peripherals, connects, through network 120 communication, such as a LAN or WAN, to a local or remote server, for instance, having an IDE 140. The IDE 130, such as Eclipse™ of JTogether™, is a tool used by the code developer team, including developers and testers, and is also in network 125 communication with the tester computer system 110. Although the components of the IDE 140 are not depicted, as previously explained, the IDE 140 is a programming environment integrated into a software application that usually provides a graphical user interface (“GUI”) builder, a text or code editor, a compiler, and/or interpreter, and a debugger or bug recording tool 160, which is depicted because of particular reference to it throughout this disclosure. Although the IDE 140 provides the environment and tools for actual code development, e.g., writing, and is normally associated with a code repository, such as Concurrent Versions System (“CVS”), Perforce® or Visual SourceSafe®, one or more databases 170 are often used in parallel with the testing phase of code development. Although not depicted as such in FIG. 1, the one or more databases 170 used in conjunction with testing are not integrated into the IDE 140, alternative embodiments may have some or all of the one or more databases 170 integrated into the IDE 140. Regardless of integration, the databases 170, are accessible to the IDE 140 and tester 110, so that the application 150 within the IDE 140 may access via network communication 120 the historical test data and current bug data stored in the databases 170.

Turning to the application 150 of the system 100, rather than the testing application existing outside of the IDE 140, the application 150, such as a plug-in, is incorporated into the IDE 140. From the application 150 within the IDE 140, the application 150 identifies a section of code for testing, and communicates through the same or a different network 120, with the databases 170 having the historical test data and current bug data for the identified section of code. In addition, the application 150 may also and optionally communicate with the code repository 130, which may have current developer statistics not found in the database(s) 170 for the current bugs determined by running the bug recording tool 160. After the application 150 ensures that the historical test data and current bug data (collectively, “data”) are in the database(s) 170, the application retrieves the data from the database(s) 170. Examples of historical test data found in and retrieved from the database(s) 170 include historical bug data, previous test scripts and their executed results, and developer statistics such as the developer's level of skill that coded historical versions of a particular section of code now under test. The application 150 then analyzes the data in a predetermined manner, and yields an estimate, which the application 150 displays to the tester 110, such via network communication 120 on a monitor associated with the tester's computer system 110. The estimate of the system 100 provides the remaining amount and types of bugs in a particular section of code, as well as a means for a tester 110 to determine a more accurate schedule and insight into writing better test scripts as a result of comparison of the historical test data to the current bug data. By seamless insertion of the application 150 into the IDE 140, then the testing and developing phases of code development process are better communicated to the interdependent team constituents, which allows more accurate scheduling and concurrent testing of the section of code before premature and buggy releases of the code occur.

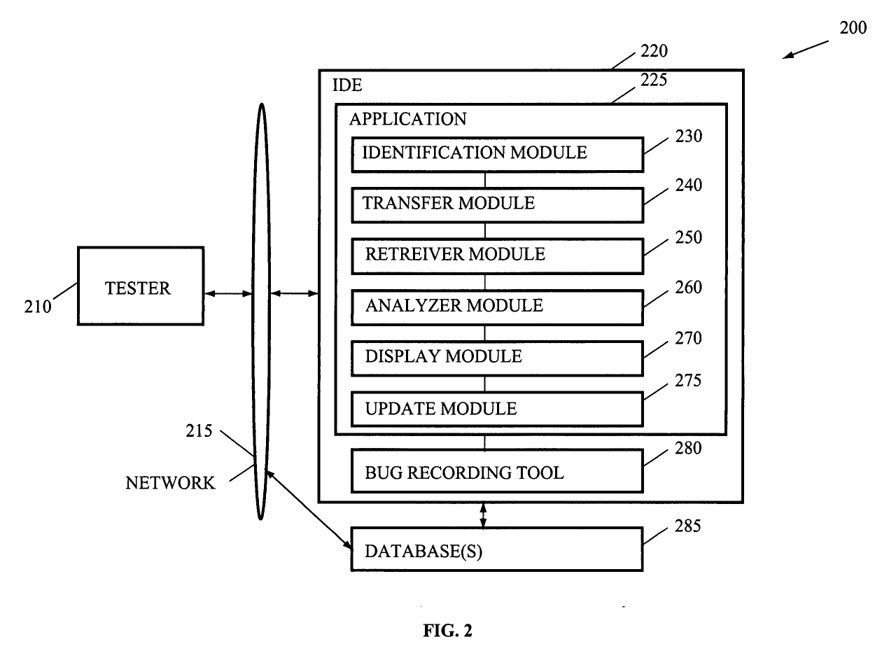

Now, moving to FIG. 2, a more detailed discussion of a system 200 for assisting in the testing of code in an integrated development environment ensures. As previously discussed and shown in FIG. 1, FIG. 2 also depicts a tester's 210 computer system in network 215 communication with the IDE 220 having the application 225, wherein the IDE 220 is likely located on a server accessible to the collaborative code development team members, and definitely to the tester 210. Unlike FIG. 1, however, FIG. 2 drills down into the functionalities of the application 225, such as a plug-in or similar modular component, integrated into the IDE 220.

Before discussing the individual and various functionalities of the application 225, it is worth including that although FIG. 2 depicts multiple, intercommunicating modules, it is understood that these functionalities could just as easily be incorporated into one large module or another arrangement without departing from the functionalities of the single application 225. Referring now to one of the modules depicted in FIG. 2, the application 225 is shown to include an identification module 230 for identifying the section of code that the tester 210 desires to test. Regardless whether the tester 210 knows the particular section of code has bugs, that is, errors or defects in software or hardware that causes a program to malfunction, the tester 210 uses the identification module 230 of the application 225 to identify the section of code to test. In practice, for example, a tester 210 likely accesses via network communication 215 a non-depicted code repository associated with the IDE 225, and checks-out at least the section of code that the tester 210 desires to test. Enabled through hardware and/or software, the identification module 230, for instance, may query the tester 210 for entry of the section of code to test upon the tester 210 making initial contact with the application 230 over the network 215. As an alternative example, the tester 210 may access the identification module 225 over a network, and through user of a user interface associated with the application 230, the tester 210 selects from a menu of choices, such as “new test,” whereby the tester 210 imports or pastes the section of code to test in a “new test” window. Many more examples are possible for identifying the section of the code to test, all of which are viewed as being within this disclosure's identification module's 230 functionality for identifying the section of code to be tested.

After identifying the section of code to test, further modules of the application 225 come to the fore. The application 225 also includes a retriever module 250 for retrieving, likely a copy of, historical test data and current bug data from one or more databases 285 in network communication 215 with the IDE 225 and the tester 210. Indeed, the databases 285 may instead be part of the IDE 225. Before turning the functionality of the retriever module 250, and its interaction with other components of the system 200, a departure into what, for example, comprises historical test data and current bug data is in order.

Historical test data normally arises from test results obtained from executed test scripts testers wrote for previous or the same versions of the particular section of code under test. For instance, the test results, for each section of code, may include: previous bugs and bug fixes; the identity of previous test scripts; whether the testing on the section of code resulted in pass or failure; how much effort was required for the writing the test scripts; how much code was required for the bug fix(es); how many times has re-testing occurred; and what level of developer skill and which developers wrote the buggy code and bug-fixes for the buggy code. This historical test data is stored in one or more databases 285. Viewing the retriever module 250 as part of a plug-in, for example, then the retriever module 250, enabled through logic reduced to software and/or hardware, retrieves the historical test data from the databases through, for example, Java® application program interfaces (“APIs”) or connectors acting in concert with the plug-in.

Unlike the historical test data, the current bug data is not initially in the one or more database(s) 285 in network communication 215 with or part of the IDE 225. The system 200 includes a bug recording tool 280, such as Bugzilla®, which is depicted as part of the IDE 225 and in communication with the application 225 and database(s) 285. In other, non-depicted embodiments, the bug recording tool 280 may not be part of the IDE 225, but the application 255 and the database(s) 285, are still in communication with the bug recording tool 225 so that the retriever module 250 may still retrieve, from the database(s) 285, current bugs generated after execution of the bug recording tool 280 for the identified section of code.

In order to retrieve the current bugs from database(s) 285, wherein one of these databases(s) may be designated specifically as a bug-tracking database 285, the application's transfer module 240 works in tandem with the bug recording tool 280, retriever module 250, and database(s) 285. Enabled by logic reduced to hardware and/or software, which, for example, optionally includes Java® connectors for a plug-in application 225 into the IDE 225, the transfer module 240 transfers and stores the current bugs generated after execution by the bug recording tool 280 into the database(s) 285. Thereafter, the retriever module 250 is able to retrieve the historical test data and the current bugs from the database(s) 285, as well as retrieve any associated current bug data, such as developer statistics that include who wrote the buggy code and the level of skill, from a non-depicted code repository associated with the IDE 285. Alternatively, the retriever module 250 may retrieve such associated current bug data from the database(s) 285 if that data is also and optionally transferred and stored in the database(s) by the transfer module 240.

Having retrieved the historical test data and current bug data for the identified section of code under test, the application 225 further includes an analyzer module 260 for analyzing this collective data. Enabled by logic in software and/or hardware, the collective data may be analyzed in a different ways to yield an estimate of the remaining amount and type of errors in the code. For example, the analyzing may occur through algorithmic analysis, such as cyclomatic complexity, which measures structural complexity of the section of code. Other possible algorithmic analyses include Halstead complexity measures, Henry and Kafura metrics, Bowles metrics, Troy and Zweben metrics, and Ligier metrics. Additionally and alternatively, the analyzing may occur by code developer skill, i.e., proficiency, or by any other programmed qualifiers, such as number of completed code revisions, wherein the qualifiers are optionally selectable by the tester 210.

Regardless how the analyzing occurs, in the end, the analyzer module 260 synthesizes the collective data to yield an estimate of the amount and type of errors remaining in the section of code. The application's 225 display module 270, enabled by coded logic and/or hardware, obtains the estimate from the analyzer module 260. Then, the display module 270 communicates over the network 215 to display the estimate on a monitor, for instance, associated with the tester's 210 computer system.

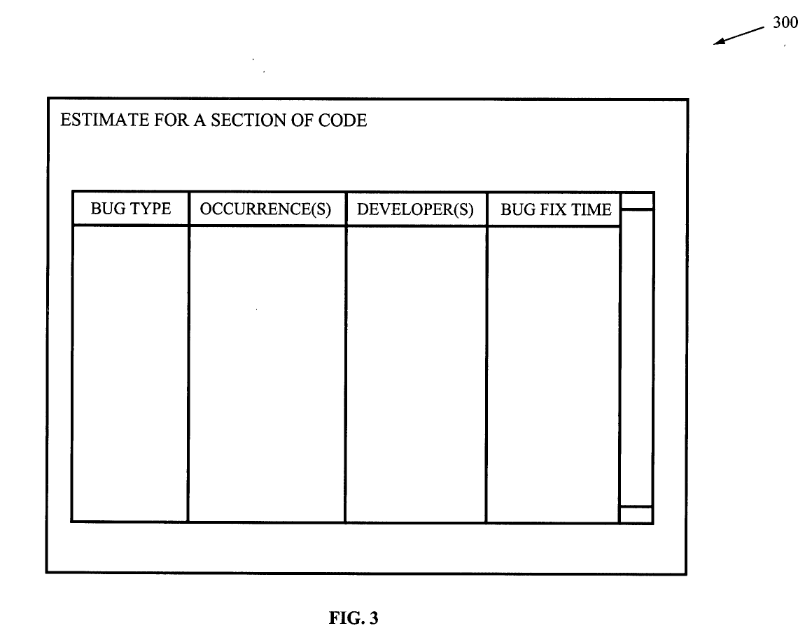

FIG. 3 shows one example of an estimate 300 for an identified section of code that may be displayed to a tester. In this example, the estimate 300 is a single page displayed to the tester. However, the estimate 300, in other example embodiments, could just as easily be displayed to the tester in different formats or include qualifiers, such developer proficiency, without departing from the scope of the invention. Regardless the format, the underlying utility that the estimate provides remains the same: by analyzing the historical test data and the current bug data, the tester can then estimate a current schedule and write better, targeted test scripts for identified amount and type of bugs remaining in a section of code. Looking at FIG. 3, this example of the estimate 300 contains four columns of data. For instance, the bug type column would show a historical bug type that also occurs in the current bugs for the section of code under test. The second column indicates the number of times this bug type occurs in the current code under test. The third column shows the developer(s) that wrote the code having the particular bug type. And, the fourth column shows the historical time required to write a bug fix to correct this bug type in the past. As shown, by this estimate 300 example, although many others exist, the tester can now better approximate a schedule for completion of a deliverable section of code, as well as more quickly write test scripts because the amount and type of bugs in the current code are identified.

Returning to FIG. 2, a further module, namely an update module 275, permits the tester to update the database(s) with the new test results generated after displaying the estimate. These new test results include the new test scripts that the tester 210 writes for the identified section of code in light of the current bug data and estimate displayed to the tester 210. Enabled through logic in software and/or hardware, the update module 275 receives and stores the new test results in the database(s) 285, so that upon re-iteration of the system 200, these just stored new test results are part of the historical test data. As an example, at the end of the testing for the section of code, the application's update module 280 may query, such as through a dialogue box, the tester 210 to import the new test results for storage into the database(s) 285 containing historical test data.

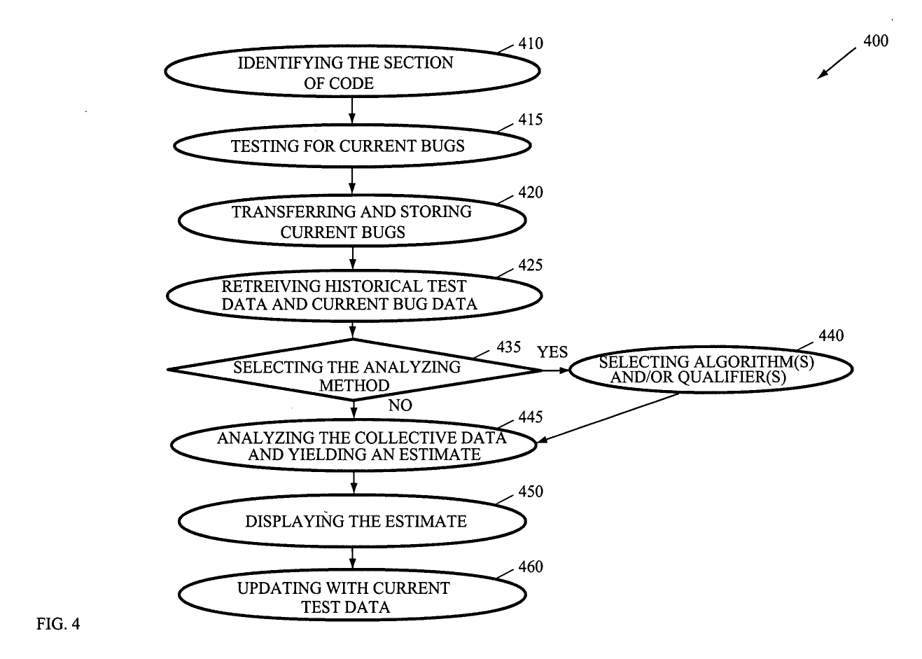

Turning now to FIG. 4, another aspect of the invention is disclosed. In particular, an embodiment of a flowchart 400 for assisting in testing code in an integrated development environment is disclosed. Flowchart 400 is for a system, such as systems 100 and 200, as shown in FIG. 1 and FIG. 2. In general, the flowchart 400 depicts an example embodiment of a method for assisting in testing a section of code by using an application, such as a plug-in, integrated into an IDE. Through use of the disclosed method in the flowchart 400, just as through use of the systems 100 and 200 in FIGS. 1 and 2, respectively, the application provides a tester with insight for accurate scheduling and what test scripts to write based on an estimate produced by the application analyzing historical test data and current bug data for the particular section of code.

Flowchart 400 begins by identifying 410 the section of code that a tester, for instance, wishes to test. Enabled by hardware and/or software logic, the identifying 410 occurs, for example, by a tester being prompted by an application, such as a Java® plug-in integrated into the IDE, to enter a section of code for testing. As a side note, in order to identify 410 the section of code, the tester's computer system is naturally in network communication with the tester's computer system.

After identifying 410 the particular section of code, the flowchart 400 continues by testing 415 the identified section of code for current bugs. Testing 415 for the current bugs in the identified section of code is optionally accomplished by a separate, commercially available application, such as TestTrack Pro® BugZilla®, or could even be another module developed and incorporated into the application within the IDE. Assuming the flowchart 400 is for a commercially available application, then, a plug-in version of the application, for example has one or more APIs for passing the identified section of code to the bug testing application, which generates the current bugs. After the testing 415 generates the current bugs in the identified section of code, the same plug-in application also has the same or different APIs for transferring and storing 420 the current bugs into one or more databases associated with the IDE. In this manner, as is often the case in code development, the current bugs may become part of a bug tracking database, which would be the same location as the historical bugs.

Moving down the flowchart 400, the application retrieves 425 the historical test data from one or more databases and the current bug data from the same or different databases, as well as optionally from a code repository associated with the IDE. Having enabling logic in software and/or hardware, the application retrieves 425 the historical test data from the database(s) through APIs. Similarly, the application retrieves 425 the current bug data from the database(s), and optionally retrieves 425 developer statistics, such as code developer skill, from the code repository. By the application retrieving 425 this collective data, the application's actions, as shown on FIG. 4, arrives at the motivation for the invention: analyzing 445 collective data to allow testers to accurately schedule deliverable code and to write test scripts quicker and on target.

Before analyzing 435 by the application, decision block 435 queries regarding the desired analyzing method. If the application optionally permits a tester to configure, i.e., select 435, the analyzing, then the tester may select 440 algorithms, qualifiers, and combinations thereof by which the analyzing 445 will occur; otherwise, the analyzing 445 occurs in the default configuration selected, perhaps, by a system administrator. As previously mentioned, the analyzing 435 may occur through algorithmic analysis, such as cyclomatic complexity, which measures structural complexity of the section of code. Other possible algorithmic analyses include Halstead complexity measures, Henry and Kafura metrics, Bowles metrics, Troy and Zweben metrics, and Ligier metrics. Additionally and alternatively, the analyzing 445 may occur by code developer skill, i.e., proficiency, or by any other programmed qualifiers, such as number of completed code revisions, wherein the qualifiers are optionally selectable by the tester.

A further aspect of the analyzing 445 includes producing the result of the analyzing 445, which is the estimate of the errors remaining in the identified section of code. As shown by the one example depicted in FIG. 3, the estimate may be displayed 450 as one page to a tester's computer system in network communication with the application integrated into the IDE. The estimate may also be one or more pages deep, as well as contain different column headers. For instance, one of the column headers may also or instead be developer proficiency level that wrote a particular part of the section of code having a specific bug type.

With the estimate displayed 450, a tester may better approximate a current schedule for completion of the section of the code. By revisiting historical test data results and analyzing them in light of the current bug data, the time and complexity known for the historical bugs can shed information on the time, i.e., scheduling, and complexity, i.e., which test scripts to write, for the current section of code under test. After the tester writes new test scripts and collects their test results, the flowchart 400 culminates in the application providing the tester the functionality to gather and store, i.e., update 460, the database(s) having the historical test data with the current test data just obtained after displaying the estimate to the tester. Through this updating 460, the next time the flowchart 400 begins, then this formerly current test data is now viewed, and is, as part of the historical test data.

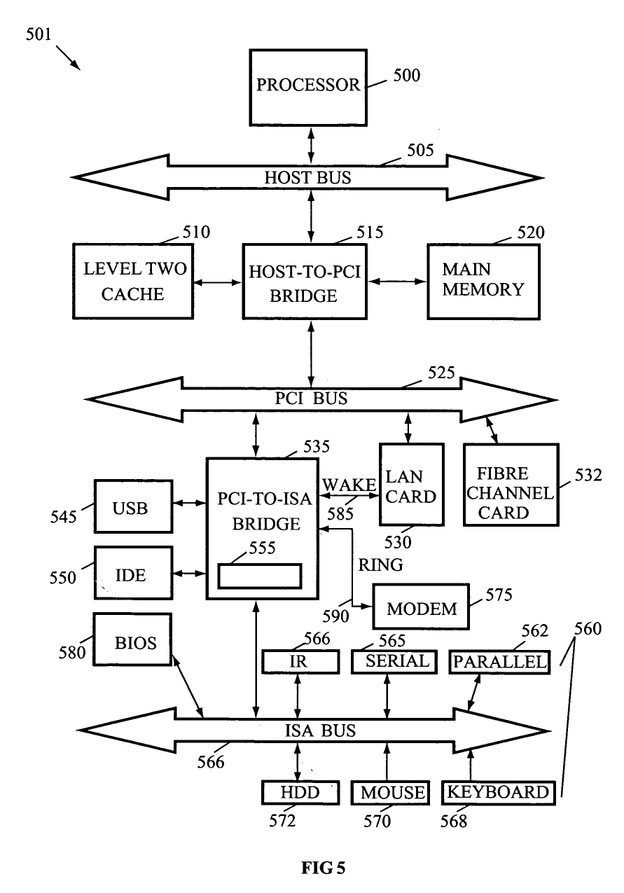

FIG. 5 illustrates an information handling system 501 which is a simplified example of a computer system, such as the developer computer systems 105, 110, and 115 and project manager computer system 120 in FIG. 1, and developer computer system 205 and project manager computer system 210 FIG. 2, which are capable of performing the operations described herein. Computer system 501 includes processor 500 which is coupled to host bus 505. A level two (L2) cache memory 510 is also coupled to the host bus 505. Host-to-PCI bridge 515 is coupled to main memory 520, includes cache memory and main memory control functions, and provides bus control to handle transfers among PCI bus 525, processor 500, L2 cache 510, main memory 520, and host bus 505. PCI bus 525 provides an interface for a variety of devices including, for example, LAN card 530. PCI-to-ISA bridge 535 provides bus control to handle transfers between PCI bus 525 and ISA bus 550, universal serial bus (USB) functionality 545, IDE device functionality 550, power management functionality 555, and can include other functional elements not shown, such as a real-time clock (RTC), DMA control, interrupt support, and system management bus support. Peripheral devices and input/output (I/O) devices can be attached to various interfaces 560 (e.g., parallel interface 562, serial interface 565, infrared (IR) interface 566, keyboard interface 568, mouse interface 570, fixed disk (HDD) 572, removable storage device 575) coupled to ISA bus 550. Alternatively, many I/O devices can be accommodated by a super I/O controller (not shown) attached to ISA bus 550.

BIOS 580 is coupled to ISA bus 550, and incorporates the necessary processor executable code for a variety of low-level system functions and system boot functions. BIOS 580 can be stored in any computer readable medium, including magnetic storage media, optical storage media, flash memory, random access memory, read only memory, and communications media conveying signals encoding the instructions (e.g., signals from a network). In order to attach computer system 501 to another computer system to copy files over a network, LAN card 530 is coupled to PCI bus 525 and to PCI-to-ISA bridge 535. Similarly, to connect computer system 501 to an ISP to connect to the Internet using a telephone line connection, modem 575 is connected to serial port 565 and PCI-to-ISA Bridge 535.

While the computer system described in FIG. 5 is capable of executing the invention described herein, this computer system is simply one example of a computer system. Those skilled in the art will appreciate that many other computer system designs are capable of performing the invention described herein.

Another embodiment of the invention is implemented as a program product for use with a computer system such as, for example, the systems 100 and 200 shown in FIG. 1 and FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

What is claimed is:

1. A method for assisting in testing a section of code in an integrated development environment, the method comprising:
identifying the section of code for the testing;
retrieving historical test data and current bug data from at least one database for the section of code;
analyzing the historical test data and the current bug data to yield an estimate of errors remaining in the section of code; and
displaying the estimate, whereby the estimate assists in scheduling and test scripting for the section of code.

2. The method of claim 1, further comprising testing, before the retrieving, the section of code for the current bugs of the current bug data.

3. The method of claim 1, further comprising storing, before the retrieving, the historical test data and the current bug data in the at least one database for the section of code.

4. The method of claim 1, further comprising selecting the method for the analyzing to yield amount and type of the errors remaining in the section of the code.

5. The method of claim 1, further comprising updating the at least one databases with current test data generated after the displaying.

6. The method of claim 1, wherein the retrieving further comprises retrieving developer statistics of the current bug data from a code repository.

7. The method of claim 1, wherein the retrieving the historical test data and the current bug data comprises retrieving developer statistics and bugs associated with the section of code.

8. The method of claim 1, wherein the analyzing comprises via at least one algorithm.

9. The method of claim 1, wherein the analyzing comprises via at least one qualifier.

10. A system for assisting in testing a section of code in an integrated development environment, the system comprising:
an application within the integrated development environment;
an identification module of the application for identifying the section of code for the testing;
a retriever module of the application for retrieving historical test data and current bug data from at least one database for the section of code;
an analyzer module of the application for analyzing the historical test data and the current bug data and for yielding an estimate of errors remaining in the section of code; and
a display module of the application for displaying the estimate.

11. The system of claim 10, further comprising a bug recording tool for recording the current bugs in the current bug data before execution by the retriever module, wherein the bug recording tool is in communication with the application.

12. The system of claim 11, further comprising a transfer module of the application for transferring and storing, after execution by the bug recording tool, the current bugs to the at least one database; and for transferring and storing developer statistics of the current bug data from the integrated development environment to the at least one database.

13. The system of claim 10, further comprising an update module for updating the at least one database with any current test data generated after execution by the display module.

14. The system of claim 10, wherein the analyzer module comprises calculating and yielding amount and type of the errors in the estimate.

15. The system of claim 10, wherein the application comprises a plug-in integrated into the integrated development environment.

16. The system of claim 15, wherein the plug-in comprises one or more connectors to the at least one database and a bug recording tool.

17. A machine-accessible medium containing instructions, which when executed by a machine, cause the machine to perform operations for assisting in testing a section of code in an integrated development environment, comprising:
identifying the section of code for the testing;
retrieving historical test data and current bug data from at least one database for the section of code;
analyzing the historical test data and the current bug data to yield an estimate of errors remaining in the section of code; and
displaying the estimate, whereby the estimate assists in scheduling and test scripting for the section of code.

18. The machine-accessible medium of claim 17, wherein the instructions further comprise instructions to perform operations for testing, before the instructions to perform operations for retrieving, the section of code for the current bugs in the current bug data.

19. The machine-accessible medium of claim 17, wherein the instructions further comprise instructions to perform operations for storing, before the instructions to perform operations for retrieving, the historical test data and the current bug data in the at least one database for the section of code.

20. The machine-accessible medium of claim 17, wherein the instructions further comprise instructions to perform operations for updating the at least one databases with current test data generated after executing the instructions to perform operations for displaying.
